(19) United States
(12) Patent Application Publication
(10) Pub. No.: US 2015/0107383 A1
(43) Pub. Date: Apr. 23, 2015

(54) POWER TOOL ADVICE

(71) Applicant: Robert Bosch GmbH, Stuttgart (DE)

(72) Inventors: Achim Duesselberg, Kirchheim/Teck (DE); Juergen Schlipf, Leonberg (DE); Immanuel Werner, St. Johann (DE)

(21) Appl. No.: 14/512,401

(22) Filed: Oct. 11, 2014

(30) Foreign Application Priority Data
Oct. 17, 2013 (DE) 10 2013 221 108.2

(51) Int. Cl. F16H 21/22

(52) U.S. Cl. CPC F16H 21/22
USPC 74/25

(57) ABSTRACT

A power tool device, in particular a portable power tool device, has at least one eccentric which is mounted so as to be rotatable about an eccentric axis. The power tool device also has at least one sheet-metal connecting rod which has at least one first bearing receptacle, configured to connect to at least one axial displacement unit, and at least one second bearing receptacle, configured to connect to the at least one eccentric.

This application claims priority under 35 U.S.C. §119 to patent application number 10 2013 221 108.2, filed on Oct. 17, 2013 in Germany, the disclosure of which is incorporated herein by reference in its entirety.

### BACKGROUND

A power tool device having an eccentric which is mounted so as to be rotatable about an eccentric axis, and having a sheet-metal connecting rod which has at least one first bearing receptacle for connecting to a piston and at least one second bearing receptacle for connecting to the eccentric is already known, wherein the two bearing receptacles are arranged perpendicularly to the eccentric axis and parallel to one another. In this case, the power tool device has additional bearing units which are fastened in the two bearing receptacles and are intended to receive corresponding bearing pins of the eccentric and of the piston.

### SUMMARY

The disclosure is based on a power tool device, in particular a portable power tool device, having at least one eccentric which is mounted so as to be rotatable about an eccentric axis, and having at least one sheet-metal connecting rod which has at least one first bearing receptacle for connecting to at least one axial displacement unit, and at least one second bearing receptacle for connecting to the at least one eccentric.

It is proposed that at least one of the bearing receptacles, preferably the at least one first bearing receptacle, is arranged at least substantially parallel to the eccentric axis, in particular at least during an operating state. In particular, both bearing receptacles can also be arranged at least substantially parallel to the eccentric axis, in particular at least during an operating state.

A “power tool device” should be understood in this context as meaning in particular a part and preferably a subassembly of a power tool. Preferably, the power tool device is intended to transmit a drive force and/or a drive torque of at least one drive assembly of the power tool device, preferably of an electric motor, in particular to at least one consumer unit to be driven. A “portable power tool device” should be understood here as meaning in particular a power tool device for a portable power tool, preferably an electric portable power tool. Here, the “electric portable power tool” may be in particular a drilling machine, a hammer drill, a percussion hammer, a saw, a plane, a screwdriver, a milling machine, a grinder, an angle grinder, a gardening tool, a construction measuring tool and/or a multifunction tool. An “eccentric” should be understood here as meaning in particular a subassembly that is mounted so as to be rotatable about a rotation axis, in particular a subassembly that is mounted so as to be rotatable about an eccentric axis, preferably a disk which may be configured in particular in the form of a circular disk, in particular with an axis of rotational symmetry spaced apart from the rotation axis, and/or which may have preferably at least one element arranged away from the rotation axis, preferably in a peripheral region of the subassembly, said element rotating about the rotation axis and being intended to transmit a drive force and/or a drive torque, preferably the drive force and/or the drive torque of the at least one drive assembly. Preferably, the element mounted away from the rotation axis is configured as an eccentric pin, advantageously as a bearing pin. The eccentric pin is intended in particular to be received in the at least one second bearing receptacle and in particular to transmit a force and/or a torque, preferably to the at least one connecting rod. Alternatively, the element mounted away from the rotation axis can also be configured as a receiving region which is intended in particular to receive a bearing pin and is in particular operatively connected to the at least one connecting rod. In this connection, an “eccentric axis” should be understood as meaning in particular an axis which defines a rotation axis of the at least one eccentric. Furthermore, a “connecting rod” should be understood as meaning in particular a subassembly or an element which is intended to convert a rotary movement, preferably of the at least one eccentric and/or at least one eccentric pin, into a translatory movement, preferably of the at least one axial displacement unit, and/or to convert a translatory movement, preferably of the at least one axial displacement unit, into a rotary movement, preferably of the at least one eccentric and/or of the at least one eccentric pin. In particular, the at least one connecting rod can also be configured as a cracked connecting rod and/or as a forked connecting rod. A “cracked connecting rod” should be understood here as meaning in particular a connecting rod which has been produced integrally and broken into two parts which are screwed together again during assembly and thus fit together in particular exactly. A “forked connecting rod” should be understood here as meaning in particular a connecting rod which is configured at least substantially in a y-shaped and/or v-shaped manner and in this case has in particular three receiving regions. A “sheet-metal connecting rod” should be understood here as meaning in particular a connecting rod which is formed from sheet metal and can in particular also be formed in a multipart manner. Thus, the at least one connecting rod has in particular only parts which have been produced from a metal sheet. In this connection, a “bearing receptacle” should be understood as meaning in particular a receiving region and/or a fastening region for a bearing unit, said region being formed preferably at least substantially at one end of the at least one connecting rod, as viewed in a direction of longitudinal extent. In particular, the at least two bearing receptacles are intended to be part of the connecting rod and thus likewise to be formed from sheet metal. In this connection, a “bearing unit” should be understood as meaning in particular a bearing bush and/or a bearing pin and/or a roller bearing and/or a needle sleeve and/or a needle bush. In particular, the bearing unit can have been pressed and/or injected and/or adhesively bonded into at least one of the bearing receptacles. Alternatively, at least one of the bearing receptacles can form at least one plain bearing surface of a plain bearing. A “direction of longitudinal extent” of an object should be understood in this connection as meaning in particular a direction of a greatest possible extent of the object. An “extent” of an object in a direction should be understood in this connection as meaning in particular a maximum spacing between two points on a perpendicular projection of the element onto a plane which is arranged parallel to the direction. An “axial displacement unit” should be understood as meaning in particular an axially movable subassembly and/or an axially movable element which is intended in particular to execute a cyclical translatory movement. Preferably, the at least one axial displacement unit has at least one axial displacement element, in particular a piston and/or at least one crosshead, and at least one bearing pin. The at least one axial displacement unit is in this case advantageously intended to drive a percussion mechanism subassembly in or counter to a percussion direction. The fact that a bearing receptacle is arranged “at least substantially parallel” to an eccentric axis should be understood here as meaning in particular that a bearing axis, defined by the bearing receptacle, of the bearing receptacle encloses an angle of at most 20°, advantageously of at most 10°, preferably of at most 5° and particularly preferably of at most 1° with the eccentric axis. A “bearing axis” of a bearing receptacle should be understood here as meaning in particular an axis which is defined by the bearing receptacle and which in particular at least partially intersects and/or penetrates through a receiving region defined by a bearing receptacle. Preferably, the bearing axis is identical to a rotation axis defined by the bearing receptacle. A “receiving region” defined by a bearing receptacle should be understood here as meaning in particular a receiving region, preferably for a bearing unit, wherein a wall delimiting the receiving region has at least one contact surface with a bearing unit. In particular, the bearing axis is at least partially surrounded and/or enclosed, preferably in the circumferential direction, to a proportion of at least 60%, in particular of at least 70%, preferably of at least 80% and particularly advantageously of at least 90% by the wall delimiting the receiving region. As a result, in particular a structurally simple configuration, in particular of the connecting rod, can be achieved. Furthermore, it is possible to dispense in particular with additional elements, in particular further bearing units, with the result that the stability and/or lifetime and/or thermal resistance of the power tool device can be increased. As a result of this saving of components and/or the configuration of the sheet-metal connecting rod, weight can furthermore be reduced, with the result that in particular energy efficiency can be increased. Moreover, costs can advantageously be lowered.

If the at least one connecting rod is produced from sheet metal with a thickness of at most 10 mm, advantageously of at most 7 mm, preferably of at most 5 mm and particularly preferably of at most 3 mm, in particular a weight of the connecting rod can be reduced. Furthermore, a material requirement and/or costs can be reduced. In this case, however, the connecting rod has in particular a stability and/or robustness similar to a conventional metal connecting rod.

It is furthermore proposed that the at least one connecting rod is formed integrally. The expression “integrally” should be understood in this connection as meaning in particular at least cohesively connected. The cohesion can be produced for example by a welding process, an adhesive-bonding process, an injection process and/or some other process that appears appropriate to a person skilled in the art. Advantageously, however, integrally should be understood as meaning formed in one piece. Preferably, this one piece is produced from a single blank, in particular from a single metal sheet. As a result, in particular the component diversity can be reduced, with the result that assembly outlay can be reduced. Furthermore, a space requirement can additionally be minimized.

Advantageously, at least one of the bearing receptacles has a plain bearing surface. A “plain bearing surface” should be understood here as meaning in particular a surface, in particular a surface of a bearing receptacle, preferably an internal surface of a bearing receptacle, which is intended to slide relative to a further plain bearing surface. Preferably, the at least two plain bearing surfaces that slide relative to one another are separated from one another by a layer of lubricant.

Advantageously, at least one internal surface or a part of an internal surface of at least one of the bearing receptacles forms a plain bearing with a part of the eccentric, in particular of the eccentric pin, preferably with an external surface of the eccentric pin, and/or with a part of the axial displacement unit, in particular with a bearing pin of the axial displacement unit, preferably with an external surface of the bearing pin of the axial displacement unit. Preferably, at least the one first bearing receptacle has a plain bearing surface. As a result, it is possible in particular to save components and reduce a mass. In particular, a service life of the power tool device can advantageously be increased.

In a further configuration of the disclosure, it is proposed that at least one of the bearing receptacles, preferably at least an internal surface of the at least one bearing receptacle, is formed in a nonround manner. Preferably, an internal surface of the at least one bearing receptacle has a nonround cross section and deviates in particular from an oval shape, in particular from a circular shape. In particular, the at least one bearing receptacle is in this case intended to receive, preferably in a form-fitting manner, a bearing unit corresponding to a nonround formation of the at least one bearing receptacle. In this case, the bearing unit is preferably pressed into the at least one bearing receptacle. In particular, it is also possible for both bearing receptacles, preferably at least internal surfaces of the two bearing receptacles, to have a nonround cross section. As a result, a relative movement of the at least one bearing receptacle with respect to the bearing unit can advantageously be prevented.

Furthermore, it is proposed that the power tool device has at least one stiffening element which is intended to increase a stiffness of the at least one connecting rod, in particular relative to a configuration in which the at least one stiffening element is dispensed with. The stiffening element can in particular be an element formed differently than the at least one connecting rod, said element being able to be connected to the at least one connecting rod in particular in a form-fitting and/or force fitting and/or cohesive manner. In this case, the at least one stiffening element can be connected to the at least one connecting rod in particular by adhesive bonding, welding, crimping, soldering, locking together, clamping, screwing and/or riveting. The at least one stiffening element can consist in particular of sheet metal, plastics material, carbon fiber and/or a composite material. As a result, in particular a stability of the connecting rod can advantageously be increased. Advantageously, the at least one stiffening element is formed integrally with the at least one connecting rod, in particular in the form of a formation and/or indentation on and/or in the at least one connecting rod, in particular in the form of a bead. As a result, a stability of the connecting rod can advantageously be increased. Furthermore, a simple configuration can be achieved.

In a further configuration of the disclosure, it is proposed that the at least one connecting rod is produced from at least two, preferably precisely two, at least substantially identical connecting rod elements. The expression “two at least substantially identical connecting rod elements” should be understood as meaning in particular that the two connecting rod elements are identical to a volumetric proportion of at least 80%, advantageously of at least 90%, preferably of at least 95% and particularly preferably of at least 98%. In particular, the at least two connecting rod elements are formed from sheet metal. In particular, the at least two connecting rod elements can be connected by a form-fit and/or cohesion and/or a force-fit. In this case, a connection can be produced for example by adhesive bonding, welding, spot welding, crimping, soldering, locking together, clamping, screwing, riveting, a tab and/or a hinge. As a result, in particular costs can be lowered and a configuration and/or stability of the at least one connecting rod can be adapted advantageously to the operating conditions.

Furthermore, it is proposed that at least one of the bearing receptacles is arranged at least substantially perpendicularly to the eccentric axis. The fact that a bearing receptacle is arranged “at least substantially perpendicularly” to an eccentric axis should be understood here as meaning in particular that a bearing axis of the bearing receptacle encloses an angle with the eccentric axis that deviates from a right angle by at most 20°, advantageously by at most 10°, preferably by at most 5° and particularly preferably by at most 2°. In the case that the connecting rod has precisely two bearing receptacles, in particular a first bearing receptacle is arranged substantially parallel to the eccentric axis and a second bearing receptacle is arranged substantially perpendicularly to the eccentric axis, wherein the two bearing receptacles enclose in particular an at least substantially right angle with one another. An “at least substantially right angle” should be understood here as meaning in particular an angle which deviates from a right angle by at most 20°, in particular by at most 10°, preferably by at most 5° and particularly advantageously by at most 2°. As a result, in particular at least one of the bearing receptacles can be configured in a structurally simple manner, while the other bearing surface, in particular without an additional bearing bush, can form a part of a plain bearing, with the result that in particular components can be saved.

Preferably, the at least one connecting rod is formed at least substantially in an elastic manner. The fact that a connecting rod is formed “at least substantially in an elastic manner” should be understood in particular as meaning that the connecting rod has at least an extent in a direction which is elastically variable in particular by at least 5%, advantageously by at least 10%, preferably by at least 20% and particularly preferably by at least 30% in a normal operating state. Preferably, the extent in the direction is in this case in particular elastically variable by at most 60%, advantageously by at most 55%, preferably by at most 50% and particularly preferably by at most 45%. In particular, the at least substantially elastic connecting rod produces an opposing force that is dependent on a variation in the extent and is preferably proportional to the variation, said opposing force counteracting the variation. Preferably, the at least one connecting rod is in this case formed from a spring steel. Preferably, the connecting rod is in this case formed at least substantially in the form of an arc of a circle and/or in an s-shaped manner in an unloaded state. As a result, in particular a structurally simple and cost-effective connecting rod can be provided. Furthermore, possible pressure spikes can be reduced by the elasticity, with the result that advantageously vibrations can be reduced.

The power tool device according to the disclosure is not in this case intended to be limited to the above-described applications and embodiments. In particular, the power tool device according to the disclosure can have a number of individual elements, components and units which differs from the number mentioned herein in order to fulfill a functionality described herein.

### BRIEF DESCRIPTION OF THE DRAWINGS

Further advantages can be gathered from the following description of the drawing. Seven exemplary embodiments of the disclosure are illustrated in the drawing. The drawing and the description contain numerous features in combination. A person skilled in the art will expediently also consider the features individually and combine them to form appropriate further combinations.

In the drawing:

FIG. 1 shows a portable power tool having a power tool device according to the disclosure,

FIG. 2 shows an enlarged illustration of the power tool device from FIG. 1,

FIG. 3 shows a sectional illustration of the power tool device from FIG. 2,

FIG. 4 shows a connecting rod of a further power tool device according to the disclosure,

FIG. 5 shows a connecting rod of an alternative power tool device according to the disclosure,

FIG. 6 shows a first bearing unit of the connecting rod according to FIG. 5,

FIG. 7 shows a second bearing unit of the connecting rod according to FIG. 5,

FIG. 8 shows a sectional illustration of the power tool device according to FIG. 5,

FIG. 9 shows a view obliquely from above of a connecting rod element of a connecting rod of a further power tool device according to the disclosure,

FIG. 10 shows a view obliquely from below of the connecting rod element from FIG. 9,

FIG. 11 shows the connecting rod assembled from two connecting rod elements according to FIGS. 9 and 10,

FIG. 12 shows a sectional illustration of the assembled connecting rod from FIG. 11,

FIG. 13 shows a view obliquely from above of a connecting rod element of a connecting rod of an alternative power tool device according to the disclosure,

FIG. 14 shows a view obliquely from below of the connecting rod element from FIG. 13,

FIG. 15 shows a connecting rod element of a connecting rod of a further power tool device according to the disclosure in an unbent state,

FIG. 16 shows the connecting rod element from FIG. 15 in a bent state,

FIG. 17 shows a bearing unit for the connecting rod of the power tool device from FIG. 15,

FIG. 18 shows the connecting rod assembled from connecting rod elements according to FIGS. 15 and 16 having the bearing bush from FIG. 17,

FIG. 19 shows a connecting rod element of a connecting rod of a further alternative power tool device according to the disclosure in an unbent state,

FIG. 20 shows the connecting rod element from FIG. 19 in a bent state, and

FIG. 21 shows the connecting rod assembled from two connecting rod elements according to FIG. 20 having the bearing bush from FIG. 17.

### DETAILED DESCRIPTION

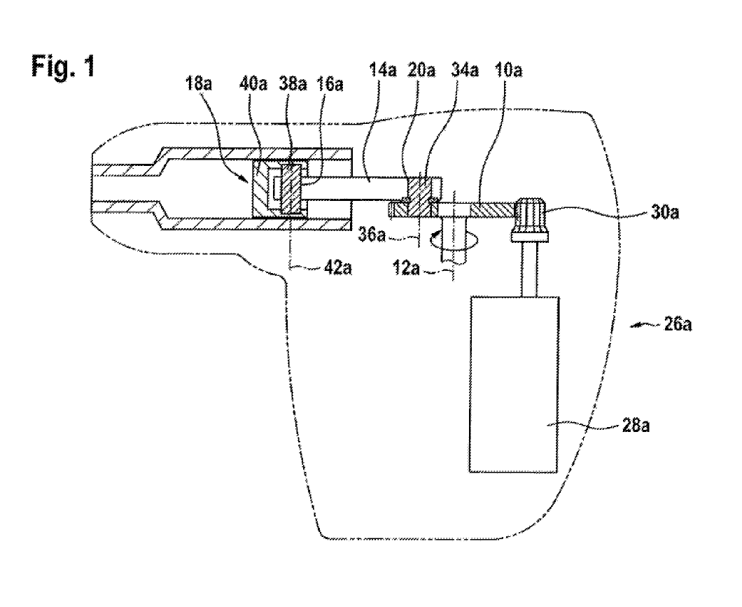

FIGS. 1, 2 and 3 show a first exemplary embodiment of the disclosure. FIG. 1 schematically shows a portable power tool 26a which in the present case is in the form of an electric hammer drill. The portable power tool 26a has a power tool device according to the disclosure. The power tool device is driven by an electric motor 28a of the portable power tool 26a. To this end, the electric motor 28a is connected to a motor shaft (not illustrated). Furthermore, the electric motor 28a is connected to a drive pinion 30a. The power tool device furthermore has an eccentric 10a. The eccentric 10a is manufactured from a hardened steel. The eccentric 10a is formed in the present case at least substantially as a disk. The eccentric 10a is furthermore arranged concentrically about the eccentric axis 12a. The eccentric 10a is arranged so as to be rotatable about the eccentric axis 12a. The eccentric 10a is in this case formed at least substantially in a rotationally symmetric manner about the eccentric axis 12a. The eccentric 10a is formed integrally. Furthermore, the eccentric 10a is connected to the drive pinion 30a. As a result of the drive pinion 30a being driven, the eccentric 10a can thus be driven. An eccentric pin 34a is fixedly connected to the eccentric 10a. The eccentric pin 34a is formed integrally. The eccentric pin 34a is connected integrally to the eccentric 10a. The eccentric pin 34a is manufactured from hardened steel. The eccentric pin 34a is thus formed from the same material as the eccentric 10a. Alternatively, however, the eccentric and/or the eccentric pin can also be formed from a different material.

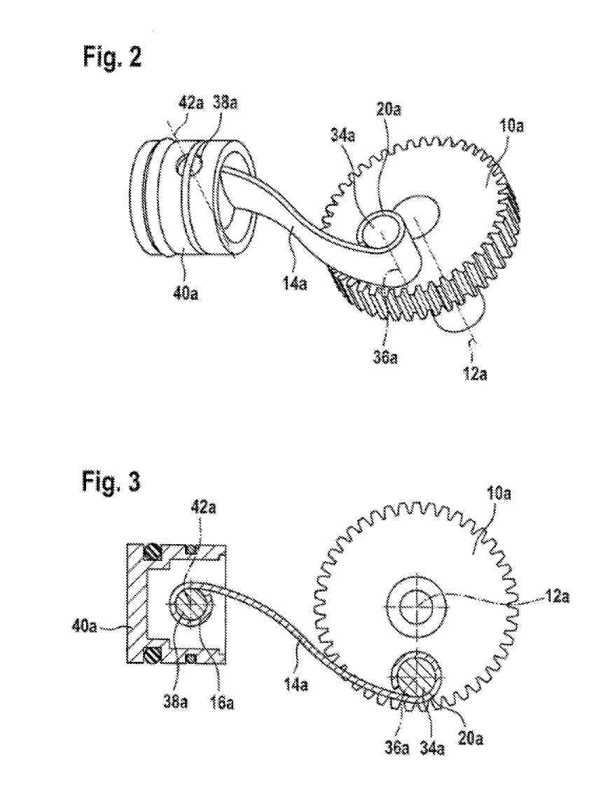

Furthermore, the power tool device has a connecting rod 14a (cf. FIGS. 2 and 3). The connecting rod 14a has a first bearing receptacle 16a. The connecting rod 14a has a second bearing receptacle 20a. The second bearing receptacle 20a serves to receive the eccentric pin 34a. The second bearing receptacle 20a forms, together with the eccentric pin 34a, at least a part of a bearing region. In this case, the eccentric pin 34a is intended to mount the connecting rod 14a so as to be at least partially rotatable about a rotation axis 36a with respect to the eccentric 10a. In the present case, an external surface of the eccentric pin 34a forms a plain bearing surface. Furthermore, an internal surface of the second bearing receptacle 20a forms a plain bearing surface. Thus, an external surface of the eccentric pin 34a forms a plain bearing with an internal surface of the second bearing receptacle 20a. In this case, it is thus possible to dispense with an additional bearing unit, with the result that in particular a stability of the connecting rod 14a can be increased. By way of the connecting rod 14a, a rotary movement of the eccentric 10a can thus be converted into a translatory movement. To this end, the first bearing receptacle 16a of the connecting rod 14a is connected to an axial displacement unit 18a. The axial displacement unit 18a has a bearing pin 38a and an axial displacement element 40a. The bearing pin 38a is formed integrally. The bearing pin 38a is manufactured from a steel. The axial displacement element 40a is manufactured at least partially from a steel. The axial displacement element 40a is configured as a piston. The bearing pin 38a is fixedly connected to the axial displacement element 40a. In this case, an external surface of the bearing pin 38a forms a plain bearing surface. Furthermore, an internal surface of the first bearing receptacle 16a forms a plain bearing surface. Thus, an external surface of the bearing pin 38a forms a plain bearing with an internal surface of the first bearing receptacle 16a. As a result, the axial displacement element 40a can drive a percussion mechanism subassembly (not illustrated) of the portable power tool 26a cyclically in or counter to a percussion direction.

The connecting rod 14a is formed entirely from sheet metal. The connecting rod 14a is in this case formed integrally. The connecting rod 14a is produced from a single piece of sheet metal. The connecting rod 14a is produced from a metal sheet with a thickness of 1.5 mm. The connecting rod 14a is produced from a rectangular sheet-metal strip, the ends of which are bent round, in particular in different directions, to form the bearing receptacles 16a, 20a. The connecting rod 14a is formed in an elastic manner. The connecting rod 14a is produced from a spring steel sheet. The connecting rod 14a consists of a spring steel in accordance with DIN EN 10089. Alternatively, the connecting rod can also be formed from the spring steel 52CrMoV4. The connecting rod 14a has a longitudinal extent of 15 mm. The connecting rod 14a has a curved geometry. The connecting rod 14a is formed at least substantially in an s-shaped manner. The contour of the connecting rod 14a in this case determines the stiffness of the connecting rod 14a. The connecting rod 14a is intended to deflect at a maximum percussion mechanism pressure. The maximum percussion mechanism pressure is between 8 bar and 12 bar depending on the operating state for a percussion mechanism caliber of 29 mm. As a result of the deflection of the connecting rod 14a, pressure spikes can be reduced with a constant impact speed. Furthermore, a vibration of the portable power tool 26a can be reduced. In the case shown, both bearing receptacles 16a, 20a of the connecting rod 14a are arranged parallel to the eccentric axis 12a, in particular at least during an operating state. Furthermore, both bearing receptacles 16a, 20a are formed at least substantially in a round manner. The two bearing receptacles 16a, 20a have different diameters. The first bearing receptacle 16a has a smaller diameter than the second bearing receptacle 20a. The rotation axes 36a, 42a are in this case likewise arranged parallel to the eccentric axis 12a.

Alternatively, the power tool device can have at least one bearing bush which is intended to be received in at least one of the bearing receptacles. Furthermore, an additional roller bearing and/or a needle bush can also be provided. At least one bearing receptacle can also be formed in a nonround manner. Furthermore, in addition to adaptation of the geometry of the connecting rod, provision can also be made of an additional, in particular integrally connected, stiffening element which can be arranged for example at the level of the two bearing receptacles and/or along a longitudinal extent of the connecting rod. A further alternative configuration could provide for at least one of the bearing receptacles to be arranged at least substantially perpendicularly to the eccentric axis.

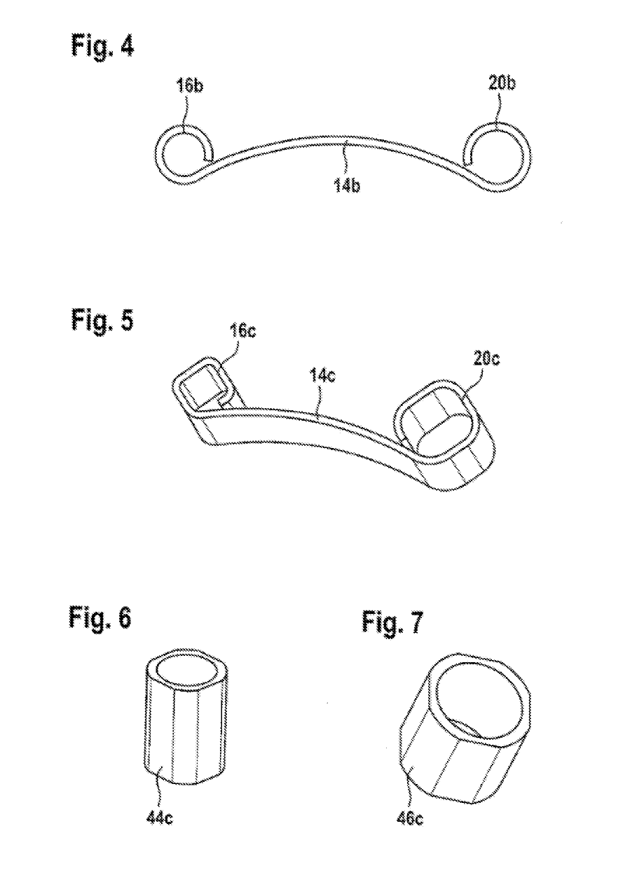

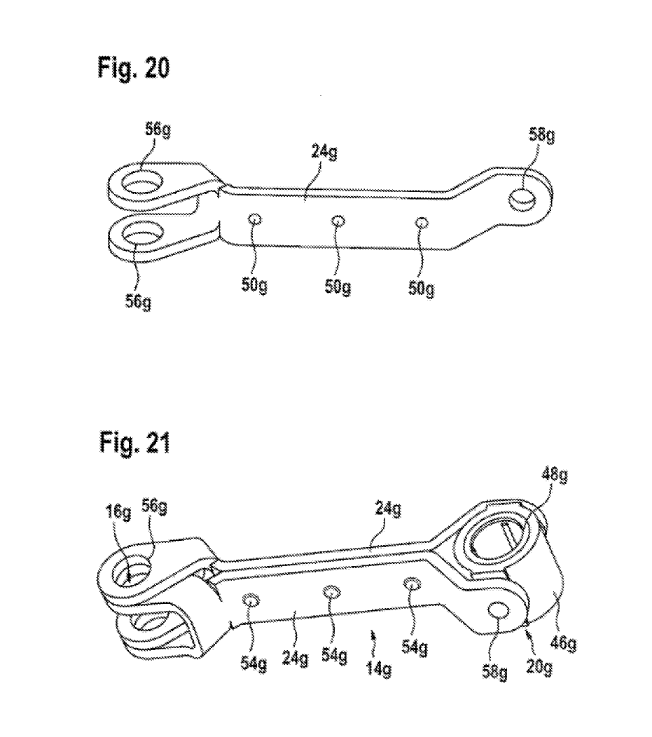

Further exemplary embodiments of the disclosure are shown in FIGS. 4 to 21. The following descriptions and the drawings are limited essentially to the differences between the exemplary embodiments, it being possible to refer in principle also to the drawings and/or the description of the other exemplary embodiments, in particular FIGS. 1 to 3, with regard to identically designated components, in particular with regard to components having the same reference signs. In order to distinguish between the exemplary embodiments, the letter a is placed after the reference signs of the exemplary embodiment in FIGS. 1 to 3. In the exemplary embodiments in FIGS. 4 to 21, the letter a is replaced by the letters b to g.

FIG. 4 shows a second exemplary embodiment of a power tool device according to the disclosure. The second exemplary embodiment differs from the first exemplary embodiment by the connecting rod 14b that is used. The connecting rod 14b has a curved geometry. However, in contrast to the first exemplary embodiment, the connecting rod 14b is formed at least substantially in the form of an arc of a circle. Furthermore, the connecting rod 14b is produced from a rectangular sheet-metal strip, the ends of which are bent round, in particular in the same direction, to form the bearing receptacles 16b, 20b.

FIGS. 5 to 8 show a third exemplary embodiment of a power tool device according to the disclosure. The third exemplary embodiment again shows a connecting rod 14c which is formed from a spring steel (cf. FIG. 5). The connecting rod 14c has a curved geometry. The connecting rod 14c is formed at least substantially in the form of an arc of a circle. The connecting rod 14c is produced from a rectangular sheet-metal strip, the ends of which are bent in the same direction to form the bearing receptacles 16c, 20c. The connecting rod 14c thus has a first bearing receptacle 16c. The connecting rod 14c has a second bearing receptacle 20c. The first bearing receptacle 16c is formed in a nonround manner, specifically in particular at least substantially in a square manner in cross section. The second bearing receptacle 20c is formed in a nonround manner, specifically in particular at least substantially in a square manner in cross section. As a result of the nonround shape, a relative movement of the bearing receptacle 16c, 20c with respect to a bearing element can be prevented. The two bearing receptacles 16c, 20c have different effective diameters and/or different side lengths. The first bearing receptacle 16c has a smaller effective diameter and/or a shorter side length than the second bearing receptacle 20c.

FIG. 6 and FIG. 7 show bearing units 44c, 46c, corresponding to the bearing receptacles 16c, 20c, of the power tool device. The bearing units 44c, 46c are configured as bearing bushes. The bearing units 44c, 46c are manufactured from aluminum. Alternatively, at least one of the bearing units can also consist of a sintered material and/or plastics material. The bearing unit 44c has an external surface which is adapted to an internal surface of the first bearing receptacle 16c. The bearing unit 44c is intended to form a form-fit with the first bearing receptacle 16c. To this end, the bearing unit 44c can be pressed into the first bearing receptacle 16c. Furthermore, the bearing unit 46c has an external surface which is adapted to an internal surface of the second bearing receptacle 20c. The bearing unit 46c is intended to form a form-fit with the second bearing receptacle 20c. To this end, the bearing unit 46c can be pressed into the second bearing receptacle 20c.

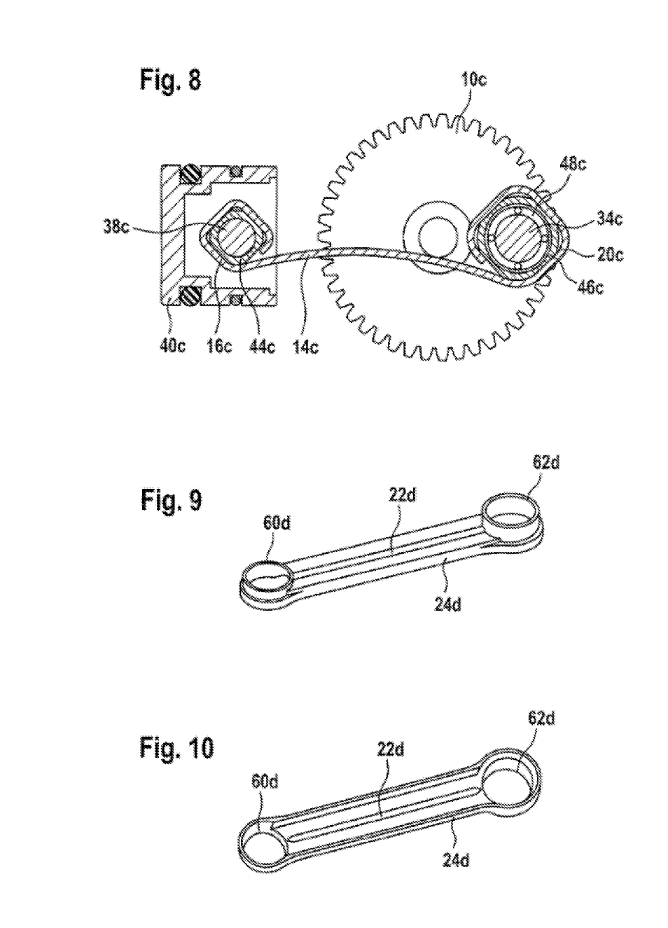

FIG. 8 shows a sectional illustration of the power tool device according to the disclosure according to the third exemplary embodiment. In this case, the first bearing receptacle 16c forms a form-fit with the bearing unit 44c. An external surface of a bearing pin 38c forms a plain bearing with an internal surface of the bearing unit 44c. Furthermore, the second bearing receptacle 20c forms a form-fit with the bearing unit 46c. Additionally, a needle sleeve 48c has been pressed into the bearing unit 46c. The bearing unit 46c, the needle sleeve 48c and an eccentric pin 34c form a roller bearing.

FIGS. 9 to 12 show a fourth exemplary embodiment of a power tool device according to the disclosure. FIGS. 9 and 10 show a first connecting rod element 24d. The connecting rod element 24d forms a first half of a connecting rod 14d. The connecting rod element 24d is formed integrally. The connecting rod element 24d is formed from a single metal sheet with a thickness of 2 mm. The connecting rod element 24d is formed from a deep-drawn steel sheet. The connecting rod element 24d is formed from a steel sheet in accordance with DIN EN 10111. Alternatively, the connecting rod can be formed from the steel DD14 or from a steel in accordance with DIN EN 10268, in particular a bake-hardening steel, a phosphorus-alloyed steel, a low-alloy steel or a relatively high-strength IF steel. The connecting rod element 24d has a first bearing receptacle half 60d. The connecting rod element 24d has a second bearing receptacle half 62d. The two bearing receptacle halves 60d, 62d are formed in a round manner. The two bearing receptacle halves 60d, 62d have different diameters. The first bearing receptacle half 60d has a smaller diameter than the second bearing receptacle half 62d. Alternatively, at least one bearing receptacle half and/or one bearing receptacle can be formed in a nonround manner. Furthermore, the power tool device has a stiffening element 22d. The power tool device has a single stiffening element 22d. The stiffening element 22d is configured as a bead in the connecting rod element 24d. The stiffening element 22d is thus formed integrally with the connecting rod element 24d. The stiffening element 22d extends at least substantially along an entire longitudinal extent of the connecting rod element 24d. The stiffening element 22d is integrally formed centrally on the connecting rod element 24d. The stiffening element 22d intersects a center of gravity of the connecting rod element 24d. Furthermore, the stiffening element 22d is introduced directly into the connecting rod element 24d during the deep drawing of the metal sheet. The stiffening element 22d is introduced into the connecting rod element 24d such that it forms an elevation on a surface of the connecting rod element 24d. The stiffening element 22d is intended to increase a stiffness of the at least one connecting rod 14d.

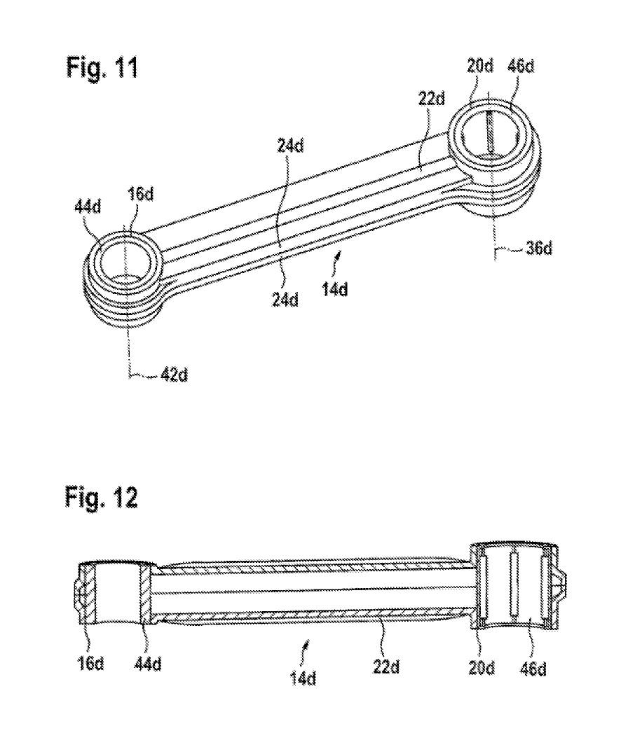

FIGS. 11 and 12 show the connecting rod 14d assembled from two identical connecting rod elements 24d. The connecting rod 14d has been produced from two identical connecting rod elements 24d. Two first bearing receptacle halves 60d form a first bearing receptacle 16d. Two second bearing receptacle halves 62d form a second bearing receptacle 20d. Furthermore, a bearing unit 44d of the power tool device has been pressed into the first bearing receptacle 16d. The bearing unit 44d is configured as a bearing bush. The bearing unit 44d is formed from a sintered material. The first bearing receptacle 16d forms a force-fit with the bearing unit 44d. An external surface of a bearing pin 38d (cf. FIG. 3) in this case forms a plain bearing with an internal surface of the bearing unit 44d. A bearing unit 46d has been pressed into the second bearing receptacle 20d. The bearing unit 46d is configured as a needle sleeve. The second bearing receptacle 20d forms a form-fit with the bearing unit 46d. The bearing unit 46d and an eccentric pin 34d (cf. FIG. 3) form in this case a roller bearing. In particular, the two at least substantially identical connecting rod elements 24d are held together only by the two bearing units 44d, 46d. In the case shown, both bearing receptacles 16d, 20d of the connecting rod 14d are arranged at least substantially parallel to an eccentric axis 12d, in particular at least during an operating state. Furthermore, both bearing receptacles 16d, 20d are formed in a round manner. The rotation axes 36d, 42d are likewise arranged parallel to the eccentric axis 12d.

Alternatively, the two connecting rod elements can additionally be connected together in a cohesive, form-fitting and/or force-fitting manner. Furthermore, an additional roller bearing can also be provided in both bearing receptacles. Furthermore, provision can also be made of only one bearing unit. In this case, however, the connecting rod elements should then be additionally connected together by way of cohesion and/or a form-fit and/or a force-fit. In addition, at least one bearing receptacle can be formed in a nonround manner. Furthermore, provision can also be made of a plurality of short stiffening elements and/or an additional metal sheet which can be arranged along a longitudinal extent of the connecting rod. A further alternative configuration could provide for at least one of the bearing receptacles to be arranged perpendicularly to the eccentric axis.

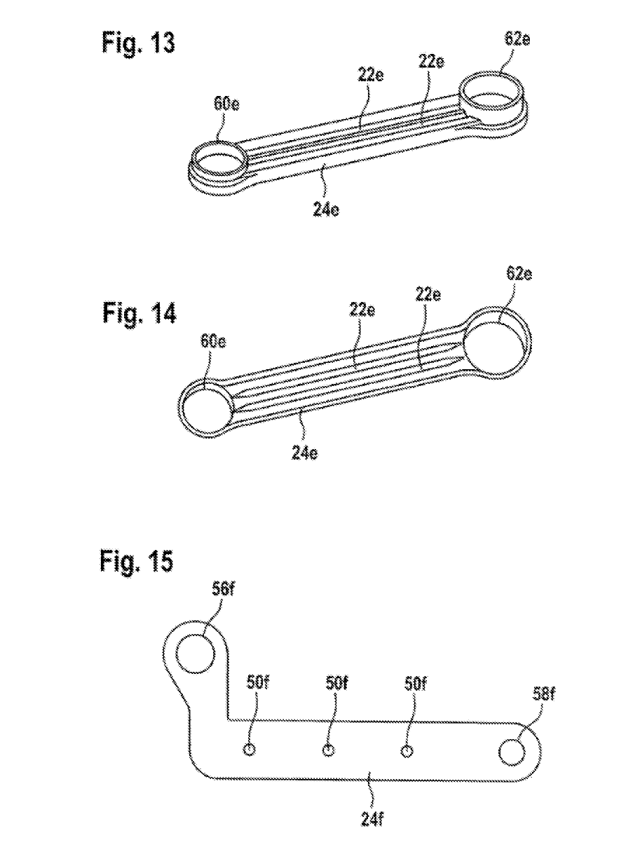

FIGS. 13 and 14 show a fifth exemplary embodiment of the disclosure. The fifth exemplary embodiment differs from the fourth exemplary embodiment by way of the number of stiffening elements 22e of a power tool device. The power tool device has two stiffening elements 22e. The stiffening elements 22e are configured as beads in a connecting rod element 24e. The stiffening elements 22e are in this case formed integrally with the connecting rod element 24e. The stiffening elements 22e extend at least substantially along an entire longitudinal extent of the connecting rod element 24e. The stiffening elements 22e are integrally formed in a symmetrical manner around a central longitudinal extent of the connecting rod element 24e. The stiffening elements 22e have been introduced into the connecting rod element 24e such that they form a depression in a surface of the connecting rod element 24e.

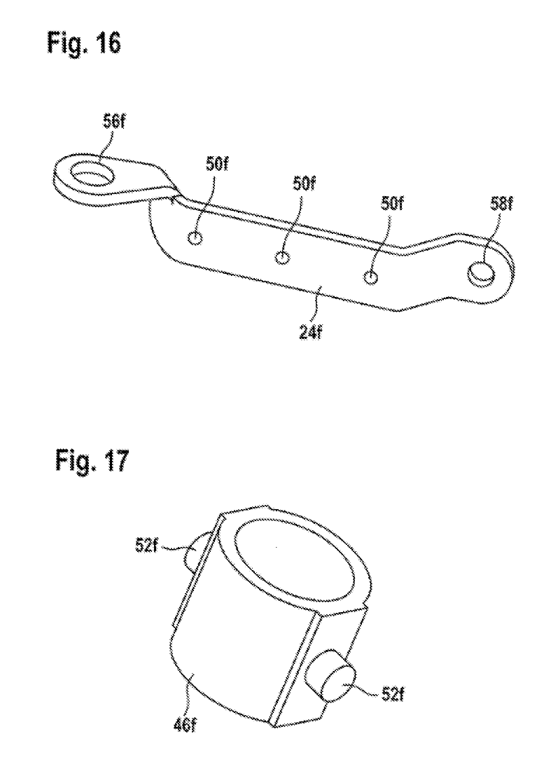

FIGS. 15 to 18 show a sixth exemplary embodiment of a power tool device according to the disclosure. FIGS. 15 and 16 show a first connecting rod element 24f of a connecting rod 14f. FIG. 15 shows the connecting rod element 24f in the form of a blank. The connecting rod element 24f forms a first half of the connecting rod 14f. The connecting rod element 24f is formed integrally. The connecting rod element 24f is formed from a single metal sheet having a thickness of 4 mm. The connecting rod element 24f has been punched out of a steel sheet. The connecting rod element 24f is thus formed from a steel sheet. The connecting rod element 24f is formed from a steel sheet in accordance with DIN EN 10268. The connecting rod element 24f has a first bearing lug 56f. The first bearing lug 56f forms a first half of a first bearing receptacle 16f. The connecting rod element 24f has a second bearing lug 58f. The second bearing lug 58f forms a first half of a second bearing receptacle 20f. The two bearing lugs 56f, 58f are formed in a round manner. The two bearing lugs 56f, 58f have different diameters. The first bearing lug 56f has a larger diameter than the second bearing lug 58f. Furthermore, the connecting rod element 24f has at least one connecting cutout 50f. In the present case, the connecting rod element 24f has three connecting cutouts 50f. The at least one connecting cutout 50f is intended to establish a connection to a second, in particular identical, connecting rod element 24f. In the present case, the at least one connecting cutout 50f is intended to establish a riveted connection to a second identical connecting rod element 24f. Alternatively, it is also possible to dispense with connecting cutouts, in particular in the case of a cohesive connection.

FIG. 16 shows the connecting rod element 24f in a bent state. In this case, the first bearing lug 56f is bent through 90° with regard to a longitudinal axis of the connecting rod element 24f. The second bearing lug 58f is bent parallel to the longitudinal axis of the connecting rod element 24f.

FIG. 17 shows a bearing unit 46f, corresponding to a second bearing receptacle 20f, of the power tool device. The bearing unit 46f is configured as a bearing bush. The bearing unit 46f is produced from a sintered material. Alternatively, the bearing unit can also be produced from plastics material and/or aluminum. The bearing unit 46f has at least one fastening element 52f. The fastening element 52f is configured as a protuberance. In the present case, the bearing unit 46f has two fastening elements 52f. The fastening element 52f fits into the first bearing lug 58f in a form-fitting manner.

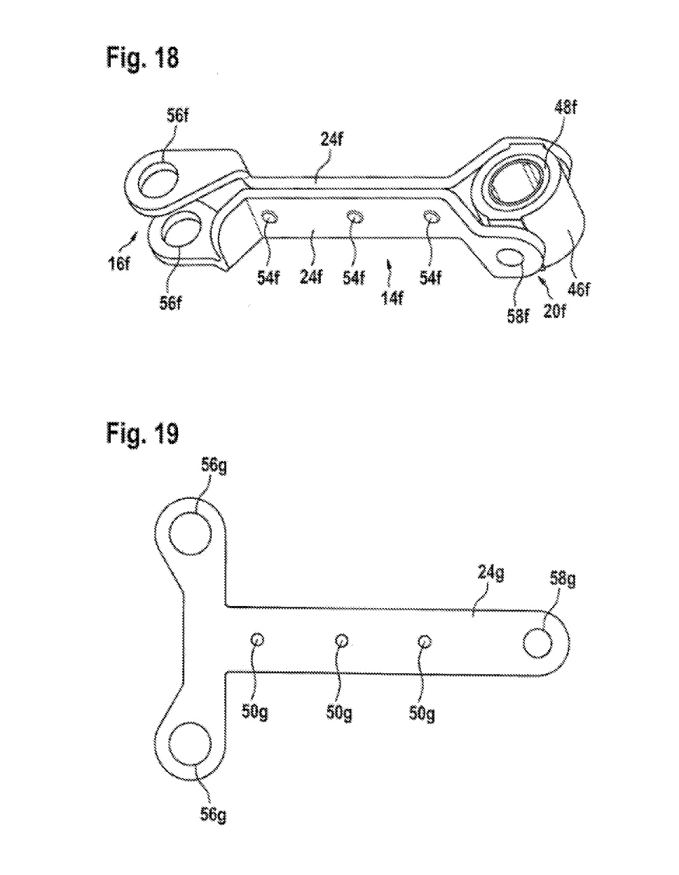

FIG. 18 shows the fully assembled connecting rod 14f with the bearing unit 46f. The connecting rod 14f has been produced from two identical connecting rod elements 24f. The two connecting rod elements 24f are connected via at least one connecting element 54f. In the present case, the two connecting rod elements 24f are connected via three connecting elements 54f. The connecting elements 54f are formed by rivets. Alternatively, a connection can also be produced by spot welding and/or adhesive bonding. Furthermore, the two first bearing lugs 56f form a first bearing receptacle 16f. The two second bearing lugs 58f form the second bearing receptacle 20f. The two bearing receptacles 16f, 20f are formed in a round manner. The two bearing receptacles 16f, 20f have different diameters. The first bearing receptacle 16f has a larger diameter than the second bearing receptacle 20f. In this case, an external surface of a bearing pin 38f forms a plain bearing surface. Furthermore, an internal surface of the first bearing receptacle 16f and/or internal surfaces of the two first bearing lugs 56f form a plain bearing surface. Thus, an internal surface of the first bearing receptacle 16f and/or internal surfaces of the two first bearing lugs 56f form a plain bearing with an external surface of a bearing pin 38f (cf. FIG. 3). In this case, it is thus possible to dispense with an additional bearing unit, with the result that in particular thermal resistance of the connecting rod 14f can be increased. Furthermore, the fastening elements 52f of the bearing unit 46f form a form-fit with the second bearing receptacle 20f and/or the two second bearing lugs 58f. Additionally, a needle sleeve 48f has been pressed into the bearing unit 46f. The bearing unit 46f, the needle sleeve 48f and an eccentric pin 34f (cf. FIG. 3) in this case form a roller bearing. The first bearing receptacle 16f is arranged parallel to an eccentric axis 12f. The second bearing receptacle 20f is arranged perpendicularly to an eccentric axis 12f. The first bearing receptacle 16f thus encloses a right angle with the second bearing receptacle 20f.

Alternatively, an additional roller bearing can also be provided in the first bearing receptacle and/or the roller bearing in the second bearing receptacle can be dispensed with. In addition, at least one bearing receptacle can be formed in a nonround manner. Furthermore, provision can also be made of at least one additional stiffening element and/or an additional metal sheet, which can be arranged along a longitudinal extent of the connecting rod. In this case, the connecting cutouts could then be arranged in an offset manner. A further alternative configuration could provide for both bearing receptacles to be arranged perpendicularly and/or parallel to the eccentric axis.

FIGS. 19 to 21 show a seventh exemplary embodiment of a power tool device according to the disclosure. The exemplary embodiment differs from the previous exemplary embodiment by way of the number of first bearing lugs 56g. A connecting rod element 24g has two first bearing lugs 56g. One of the first bearing lugs 56g is in this case formed so as to be longer than the other first bearing lug 56g. The bearing lugs 56g are arranged at least substantially in a symmetrical manner around a center axis of the connecting rod element 24g. In this case, the two first bearing lugs 56g are bent through 90° with regard to a longitudinal axis of the connecting rod element 24g. Furthermore, the first bearing lugs 56g are bent so as to be offset somewhat upwardly and/or downwardly with regard to a longitudinal edge of the connecting rod element 24g, such that, in an assembled state of the two connecting rod elements 24g, the four first bearing lugs 56g form a first bearing receptacle 16g of a connecting rod 14g. An internal surface of the first bearing receptacle 16g and/or internal surfaces of the first bearing lugs 56g form a plain bearing with an external surface of a bearing pin 38g (cf. FIG. 3). As a result of the greater number of first bearing lugs 56g, in particular a running surface for the bearing pins 38g is enlarged, with the result that a wear behavior can be improved.

What is claimed is:

1. A power tool device, comprising:
at least one eccentric mounted so as to be rotatable about an eccentric axis; and
at least one sheet-metal connecting rod, including:
at least one first bearing receptacle configured to connect to at least one axial displacement unit; and
at least one second bearing receptacle configured to connect to the at least one eccentric,
wherein at least one of the at least one first bearing receptacle and the at least one second bearing receptacle is arranged at least substantially parallel to the eccentric axis.

2. The power tool device according to claim 1, wherein the at least one connecting rod is produced from sheet metal with a thickness of less than or equal to 10 mm.

3. The power tool device according to claim 1, wherein the at least one connecting rod is formed integrally.

4. The power tool device according to claim 1, wherein at least one of the at least one first bearing receptacle and the at least one second bearing receptacle has a plain bearing surface.

5. The power tool device according to claim 1, wherein at least one of the at least one first bearing receptacle and the at least one second bearing receptacle is formed in a nonround manner.

6. The power tool device according to claim 1, further comprising:
at least one stiffening element configured to increase a stiffness of the at least one connecting rod.

7. The power tool device according to claim 6, wherein the at least one stiffening element is formed integrally with the at least one connecting rod.

8. The power tool device according to claim 1, wherein the at least one connecting rod is produced from at least two at least substantially identical connecting rod elements.

9. The power tool device according to claim 1, wherein at least one of the at least one first bearing receptacle and the at least one second bearing receptacle is arranged at least substantially perpendicularly to the eccentric axis.

10. The power tool device according to claim 1, wherein the at least one connecting rod is formed at least substantially in an elastic manner.

11. A sheet-metal connecting rod for a power tool device, the sheet-metal connecting rod comprising:
at least one first bearing receptacle configured to connect to at least one axial displacement unit; and
at least one second bearing receptacle configured to connect to at least one eccentric, the at least one eccentric mounted in the power tool device so as to be rotatable about an eccentric axis,
wherein at least one of the at least one first bearing receptacle and the at least one second bearing receptacle is arranged at least substantially parallel to the eccentric axis.

12. A power tool, comprising:
at least one power tool device, including:
at least one eccentric mounted so as to be rotatable about an eccentric axis; and
at least one sheet-metal connecting rod, including:
at least one first bearing receptacle configured to connect to at least one axial displacement unit; and
at least one second bearing receptacle configured to connect to the at least one eccentric,
wherein at least one of the at least one first bearing receptacle and the at least one second bearing receptacle is arranged at least substantially parallel to the eccentric axis.

13. The power tool device according to claim 1, wherein the power tool device is a portable power tool device.

14. The power tool according to claim 12, wherein the power tool is a portable power tool.
